(19) United States
(12) Patent Application Publication
(10) Pub. No.: US 2025/0155629 A1
(43) Pub. Date: May 15, 2025

(54) BACKLIGHT MODULE

(71) Applicant: DARWIN PRECISIONS CORPORATION, Hsinchu County (TW)

(72) Inventor: Jian-Jhih You, Hsinchu County (TW)

(21) Appl. No.: 18/946,938

(22) Filed: Nov. 14, 2024

(30) Foreign Application Priority Data
Nov. 15, 2023 (TW) 112144105

(51) Int. Cl. F21V 8/00

(52) U.S. Cl. CPC G02B 6/0053

(57) ABSTRACT

A backlight module includes a light-emitting element, a light guide plate, a first optical film, and a second optical film. The first optical film has two opposite surfaces and a side surface located between the two surfaces. The side surface and the light-inlet surface are located on a same side of the backlight module. One of the two surfaces has a first columnar optical structure, and an included angle between a first axial direction of the first columnar optical structure and the side surface meets the following equation: A1≤90°. The other surface has a second columnar optical structure, and an included angle between a second axial direction and the first axial direction meets the equation: A2≤90°. The second optical film has a surface having a third columnar optical structure. An angle between an axial direction of the third columnar optical structure and the first axial direction meets the equation: A3≤45°.

### FIELD OF THE INVENTION

The present invention relates to a light source module, and particularly relates to a backlight module.

### BACKGROUND OF THE INVENTION

A liquid crystal display mainly includes a backlight module, a display panel, an outer frame, and the like. Owing to different directions of light-emitting elements, the backlight module can also include a side light type backlight module and a direct type backlight module. Further, the side light type backlight module features thin depth and low cost, such that a liquid crystal display using the side light type backlight module has been widely applied to daily life.

However, to increase the light emergent brightness of the backlight module, a known backlight module is often provided with many optical films in a light emergent direction of a light guide plate, resulting in a too-thick known backlight module. In addition, in the prior art, a light emergent viewing angle cannot be effectively concentrated in a configuration mode of the optical films, such that the light emergent brightness of the backlight module in a front viewing angle is insufficient, resulting in poor contrast. Furthermore, too many optical films cause the problem of insufficient brightness of the known backlight module.

### SUMMARY OF THE INVENTION

The present invention provides a backlight module to improve the brightness and contrast, and reduce the thickness.

To achieve one or a portion of or all of the objects or other objects, the backlight module provided by the present invention includes a light-emitting element, a light guide plate, a first optical film, and a second optical film. The light guide plate has a light-inlet surface and a light-outlet surface connected to each other. The light-inlet surface is opposite to the light-emitting element. The first optical film has a first surface, a second surface, and a side surface. The first surface is opposite to the second surface and faces the light-outlet surface. The side surface is located between the first surface and the second surface, and the side surface and the light-inlet surface are located on a same side of the backlight module. The first surface has a plurality of first columnar optical structures, and a first axial direction of each of the first columnar optical structures extends along the first surface. The second surface has a plurality of second columnar optical structures, and a second axial direction of each of the second columnar optical structures extends along the second surface. An included angle between each of the first axial directions and the side surface is A1, and an included angle between each of the second axial directions and each of the first axial directions is A2, and A1≤90°, A2≤90°. The second optical film is arranged opposite to the first optical film and has a third surface opposite to the second surface. The third surface has a plurality of third columnar optical structures, and a third axial direction of each of the third columnar optical structures extends along the third surface. An included angle between each of the third axial directions and each of the first axial directions is A3, and A3≤45°.

In an embodiment of the present invention, a shape of each of the first columnar optical structures includes a triangular prism and has two first base angles connected to the first surface. Angles of the two first base angles of each of the first columnar optical structures are equal to each other and are between 1° and 60°, respectively.

In an embodiment of the present invention, each of the first columnar optical structures can have a first top opposite to the first surface. A distance between the two first tops of the two adjacent first columnar optical structures in the first columnar optical structures is, for example, between 25 um and 50 um.

In an embodiment of the present invention, a shape of the first columnar optical structure can include a triangular prism, and the first top can include a vertex angle of the first columnar optical structure.

In an embodiment of the present invention, a refractive index of each of the first columnar optical structures is, for example, greater than 1.5.

In an embodiment of the present invention, a shape of the second columnar optical structure can include a triangular prism and has two second base angles connected to the second surface. Angles of the two second base angles of each of the second columnar optical structures are equal to each other and are between 1° and 60°, respectively.

In an embodiment of the present invention, the second columnar optical structure can have, for example, a second top opposite to the second surface. A distance between the two second tops of the two adjacent second columnar optical structures in the second columnar optical structures can be, for example, between 25 um and 50 um.

In an embodiment of the present invention, a shape of the second columnar optical structure can include a triangular prism, and the second top can include a vertex angle of the second columnar optical structure.

In an embodiment of the present invention, a refractive index of each of the second columnar optical structures is, for example, greater than 1.5.

In an embodiment of the present invention, a shape of the third columnar optical structure includes, for example, a triangular prism and has two third base angles connected to the third surface. Angles of the two third base angles of each of the third columnar optical structures are equal to each other and are between 1° and 60°, respectively.

In an embodiment of the present invention, the third columnar optical structure can have, for example, a third top opposite to the third surface. A distance between the two third tops of the two adjacent third columnar optical structures in the third columnar optical structures can be between 25 um and 50 um.

In an embodiment of the present invention, a shape of the third columnar optical structure can include a triangular prism, and the third top can include a vertex angle of the third columnar optical structure.

In an embodiment of the present invention, a refractive index of each of the third columnar optical structures is, for example, greater than 1.5.

In an embodiment of the present invention, the light guide plate further has, for example, a fourth surface. The fourth surface is opposite to the light-outlet surface and has a plurality of triangular prism optical structures. A fourth axial direction of each of the triangular prism optical structures extends along the fourth surface and the light-inlet surface. The triangular prism optical structure has a fourth base angle and a fifth base angle, respectively. The fourth base angle and the fifth base angle are connected to the fourth surface and the fourth base angle of each of the triangular prism optical structures is closer to the light-inlet surface compared with the fifth base angle. The angle of the fourth base angle can be larger than the angle of the fifth base angle.

In an embodiment of the present invention, the backlight module further includes, for example, an optical film. The optical film is arranged opposite the third surface and includes a light-diffusing sheet or a brightness-enhancing sheet.

In an embodiment of the present invention, the backlight module can further include a reflecting sheet. The reflecting sheet is arranged on a side, opposite to the first optical film, of the light guide plate.

The backlight module provided by the present invention uses the first optical film and the second optical film, where the first columnar optical structure can diffuse an incident light beam, such that the light beam can be more uniformly incident to the second columnar optical structure, and the second columnar optical structure can reduce an emergent opening angle of the light beam at a vertical viewing angle. On the other hand, the third columnar optical structure of the second optical film can reduce the emergent opening angle of the light beam at a horizontal viewing angle, such that the light beam approximately emerges in a forward direction when being emergent to the third surface of the second optical film. Based on the above, the backlight module provided by the present invention is configured with the two optical films (the first optical film and the second optical film), so that the emergent brightness at the forward viewing angle can be effectively improved. Therefore, the backlight module provided by the present invention can improve the brightness and contrast and reduce the thickness.

Other objectives, features and advantages of the invention will be further understood from the further technological features disclosed by the embodiments of the invention wherein there are shown and described preferred embodiments of this invention, simply by way of illustration of modes best suited to carry out the invention.

### BRIEF DESCRIPTION OF THE DRAWINGS

FIG. 1 is a schematic diagram of a backlight module in an embodiment of the present invention;

FIG. 2 is a three-dimensional schematic diagram of a first optical film in FIG. 1;

FIG. 3 is a three-dimensional schematic diagram of a second optical film in FIG. 1;

FIG. 4 is a partial schematic diagram of the first optical film in FIG. 2 at another viewing angle;

FIG. 5 is a schematic diagram of a backlight module in another embodiment of the present invention; and

FIG. 6 is a schematic diagram of a backlight module in another embodiment of the present invention.

### DETAILED DESCRIPTION OF PREFERRED EMBODIMENTS

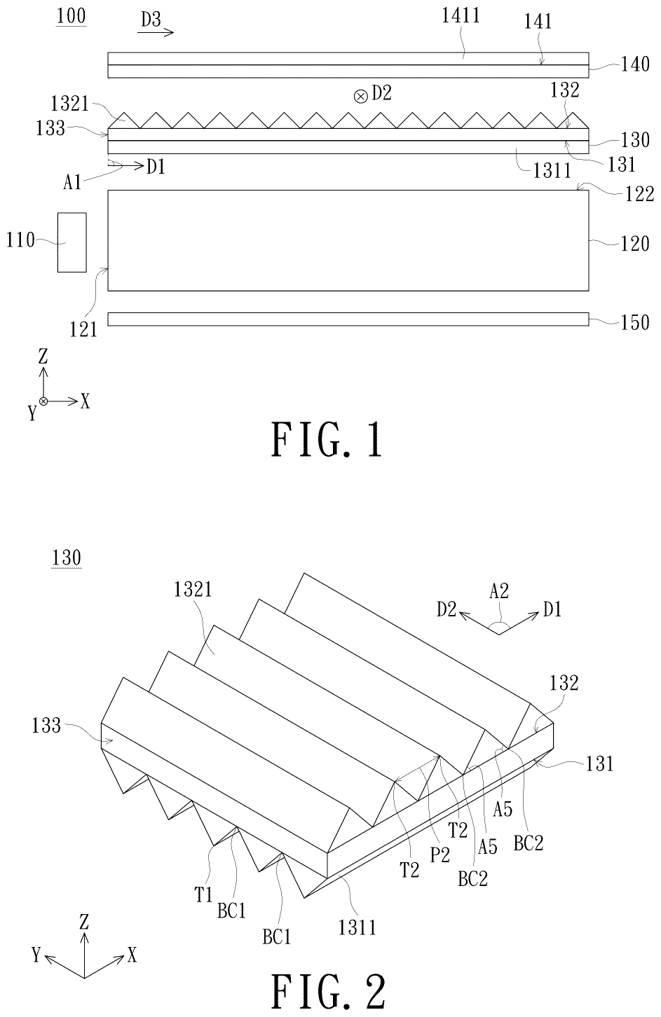

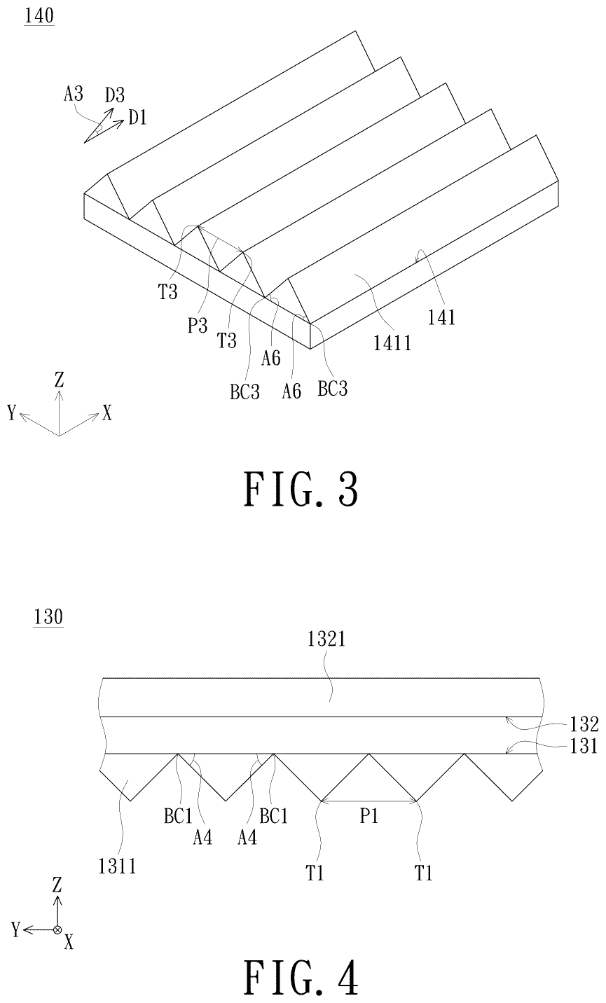

FIG. 1 is a schematic diagram of a backlight module in an embodiment of the present invention. FIG. 2 is a three-dimensional schematic diagram of a first optical film in FIG. 1. FIG. 3 is a three-dimensional schematic diagram of a second optical film in FIG. 1. FIG. 4 is a partial schematic diagram of the first optical film in FIG. 2 at another viewing angle. Referring to FIG. 1 first, a backlight module 100 includes a light-emitting element 110, a light guide plate 120, a first optical film 130, and a second optical film 140. The light guide plate 120 has a light-inlet surface 121 and a light-outlet surface 122 connected to each other. The light-inlet surface 121 is opposite to the light-emitting element 110. The first optical film 130 has a first surface 131, a second surface 132, and a side surface 133. The first surface 131 is opposite to the second surface 132 and faces the light-outlet surface 122. The side surface 133 is located between the first surface 131 and the second surface 132, and the side surface 133 and the light-inlet surface 121 are located on the same side of the backlight module 100. In detail, the side surface 133, the light-inlet surface 121, and the light-emitting element 110 are located on the same side of the backlight module 100. Referring to FIG. 1 and FIG. 2 together, the first surface 131 has a plurality of first columnar optical structures 1311, and a first axial direction D1 of each of the first columnar optical structures 1311 extends along the first surface 131. The second surface 132 has a plurality of second columnar optical structures 1321, and a second axial direction D2 of each of the second columnar optical structures 1321 extends along the second surface 132. The included angle between the first axial directions D1 and the respective side surface 133 is A1 (shown in FIG. 1), and the included angle between the second axial directions D2 and the respective first axial directions D1 is A2 (shown in FIG. 2), wherein A1≤90°, A2≤90°. Referring to FIG. 1 and FIG. 3 together, the second optical film 140 is arranged opposite to the first optical film 130 and has a third surface 141 opposite to the second surface 132. The third surface 141 has a plurality of third columnar optical structures 1411, and a third axial direction D3 of each of the third columnar optical structures 1411 extends along the third surface 141. The included angle between the third axial direction D3 and the respective first axial direction D1 is A3 (shown in FIG. 3), wherein A3≤45°.

It is to be noted that in the embodiment, the third axial direction D3 and the first axial direction D1 are, for example, substantially parallel to each other, so the included angle A3 is about 0°. However, to clearly mark and describe the included angle A3, the included angle A3 shown in FIG. 3 is slightly greater than 0°, which is taken as an example. However, the present invention does not limit the numerical value of the included angle A3.

Referring to FIG. 1 continuously, the light-emitting element 110 in the embodiment can include a light-emitting diode (LED). In detail, in an embodiment, the light-emitting element 110 can be a non-packaged light-emitting chip cut from a wafer, for example, a light-emitting diode chip. For example, the light-emitting diode chip may be a grain-sized nitride light-emitting diode chip emitting blue light at the main wavelength, which is not limited herein.

In the embodiment, the material of the light guide plate 120 can include polymethyl methacrylate (PMMA). However, in other embodiments, the material of the light guide plate 120 can include a cycloolefin polymer (COP) or polycarbonate (PC). In addition, the light guide plate 120 in the embodiment can be formed by way of hot press molding or injection molding, which is not limited in the present invention. Incidentally, in the embodiment, the light-outlet surface 122 of the light guide plate 120 can have a prism structure, which is not limited in the present invention.

Referring to FIG. 1 and FIG. 2 together, the first optical film 130 in the embodiment is, for example, a compound prismatic lens. In other words, the shape of the first columnar optical structure 1311 and the shape of the second columnar optical structure 1321 can respectively include a triangular prism, which is not limited in the present invention. It is to be noted that A2 is satisfied: 45°≤A2≤90° in an embodiment, and A2 is satisfied: 80°≤A2≤90° in another embodiment. For example, the first axial direction D1 can extend in the direction X, and the second axial direction D2 can extend in the direction Y. Therefore, the first axial direction D1 and the second axial direction D2 can be substantially perpendicular to each other, and the included angle A2 can be about 90°. In another embodiment, the included angle A1 can be about 90°. For example, the side surface 133 can extend along the Y-Z plane, and the first axial direction D1 can extend in the direction X and is substantially perpendicular to the side surface 133. However, the present invention does not limit the numerical value of the included angles A1 and A2.

In the embodiment, the first columnar optical structure 1311 can receive a light beam emergent from the light guide plate 120. In detail, the first columnar optical structure 1311 can diffuse the light beam to the whole first surface 131, such that the light beam can be incident to the second surface 132 with more uniform brightness. Referring to FIG. 2 and FIG. 4 together, in the embodiment, the first columnar optical structure 1311 has, for example, two first base angles BC1 connected to the first surface 131. The angles A4 (shown in FIG. 4) of the two first base angles BC1 of each of the first columnar optical structures 1311 are equal to each other and are between 1° and 60°, respectively. Specifically, the angle A4 of the first base angle BC1 can affect the effect of the first columnar optical structure 1311 diffusing the light beam. The first columnar optical structure 1311 in the embodiment can diffuse the light beam more uniformly. In an embodiment, the angles A4 of the two first base angles BC1 can be respectively between 5° and 60°, but the present invention does not limit the specific numerical values. On the other hand, in the embodiment, the first columnar optical structure 1311 can have a first top T1 opposite to the first surface 131. The distance P1 (shown in FIG. 4) between the two first tops T1 of the two adjacent first columnar optical structures 1311 in the first columnar optical structures 1311 is, for example, between 25 um and 50 um. Further, the distance P1 between the two first tops T1 can affect a separation distance between a bright ray and a dark ray of the light beam emergent from the first optical film 130, such that the optical taste of the first optical film 130 can be further improved. Incidentally, because the shape of the first columnar optical structure 1311 can include the triangular prism, the first top T1 can be a vertex angle of the first columnar optical structure 1311. However, in other embodiments, a shape of the first top T1 can be different according to the first columnar optical structure 1311, but the present invention does not over-limit the shape. In the embodiment, a refractive index of each of the first columnar optical structures 1311 is, for example, greater than 1.5. The refractive index of the first columnar optical structure 1311 can affect the angle at which the light beam is emergent. Therefore, the first columnar optical structure 1311 can diffuse the light beam more uniformly. In an embodiment, the refractive index of each of the first columnar optical structures 1311 can be approximately between 1.54 and 1.57, but the present invention does not limit the specific numerical value.

Referring to FIG. 1 and FIG. 2 again, in the embodiment, the light beam can be emergent from the second columnar optical structure 1321 to the second optical film 140. Specifically, the second columnar optical structure 1321 can reduce the emergent opening angle of the light beam at the vertical viewing angle, such that the light beam approximately emerges in a forward direction at the vertical viewing angle. Referring to FIG. 2 continuously, the second columnar optical structure 1321 can have two second base angles BC2 connected to the second surface 132. The angles A5 of the two second base angles BC2 of each of the second columnar optical structures 1321 are equal to each other and are between 1° and 60°, respectively. Further, the angles A5 of the two second base angles BC2 can affect the effect of reducing the emergent opening angle of the light beam. The second columnar optical structure 1321 in the embodiment can diffuse the light beam more uniformly. In an embodiment, the angles A5 of the two second base angles BC2 can be respectively between 5° and 60°, but the present invention does not limit specific numerical values. In addition, in the embodiment, the second columnar optical structure 1321 can have a second top T2 opposite to the second surface 132. The distance P2 between the two second tops T2 of the two adjacent second columnar optical structures 1321 in the second columnar optical structures 1321 can be, for example, between 25 um and 50 um. Similarly, the distance P2 between the two second tops T2 can affect the separation distance between the bright ray and the dark ray of the light beam, such that the optical taste of the first optical film 130 can be further improved. Incidentally, because the shape of the second columnar optical structure 1321 can include the triangular prism, the second top T2 can be a vertex angle of the second columnar optical structure 1321. However, in other embodiments, the shape of the second top T2 can be different according to the second columnar optical structure 1321, but the present invention does not over-limit the shape. In the embodiment, the refractive index of each of the second columnar optical structures 1321 is, for example, greater than 1.5. The refractive index of the second columnar optical structure 1321 can affect the effect of reducing the emergent opening angle of the light beam. Therefore, the second columnar optical structure 1321 can diffuse the light beam more uniformly. In an embodiment, the refractive index of each of the second columnar optical structures 1321 is, for example, between 1.57 and 1.63, but the present invention does not limit the specific numerical value.

Referring to FIG. 1 and FIG. 3 again, the second optical film 140 in the embodiment is, for example, a prism lens. In other words, the shape of the third columnar optical structure 1411 includes, for example, a triangular prism, but the present invention does not limit the shape. In the embodiment, the second optical film 140 can receive a light beam emergent from the first optical film 130. In detail, the second optical film 140 can reduce the emergent opening angle of the light beam at the horizontal viewing angle, such that the light beam approximately emerges in a forward direction at the horizontal viewing angle.

Referring to FIG. 3 continuously, the third columnar optical structure 1411 can have two third base angles BC3 connected to the third surface 141. The angles A6 of the two third base angles BC3 of each of the third columnar optical structures 1411 are equal to each other and are between 1° and 60°, respectively. In detail, the angles A6 of the two third base angles BC3 can affect the effect of reducing the emergent opening angle of the light beam. The third columnar optical structure 1411 in the embodiment can diffuse the light beam more uniformly. In an embodiment, the angles A6 of the two third base angles BC3 can be respectively between 5° and 60°, but the present invention does not limit the specific numerical values. In addition, in the embodiment, the third columnar optical structure 1411 can have, for example, a third top T3 opposite to the third surface 141. The distance P3 between the two third tops T3 of the two adjacent third columnar optical structures 1411 in the third columnar optical structures 1411 can be between 25 um and 50 um. Further, the distance P3 between the two third tops T3 can affect the separation distance between the bright ray and the dark ray of the light beam, such that the optical taste of the second optical film 140 can be further improved. Incidentally, because the shape of the third columnar optical structure 1411 can include a triangular prism, the third top T3 can be a vertex angle of the third columnar optical structure 1411. However, in other embodiments, the shape of the third top T3 can be different according to the third columnar optical structure 1411, but the present invention does not limit the shape. In the embodiment, the refractive index of each of the third columnar optical structures 1411 is, for example, greater than 1.5. The refractive index of the third columnar optical structure 1411 can affect the effect of reducing the emergent opening angle of the light beam. Therefore, the third columnar optical structures 1411 can diffuse the light beam more uniformly. In an embodiment, the refractive index of each of the third columnar optical structures 1411 is, for example, between 1.54 and 1.57, but the present invention does not limit the specific numerical value.

Compared with the prior art, the backlight module 100 in the embodiment uses the first optical film 130 and the second optical film 140, where the first columnar optical structure 1311 can diffuse an incident light beam, such that the light beam can be more uniformly incident to the second columnar optical structure 1321, and the second columnar optical structure 1321 can reduce an emergent opening angle of the light beam at a vertical viewing angle. On the other hand, the third columnar optical structure 1411 of the second optical film 140 can reduce the emergent opening angle of the light beam at a horizontal viewing angle, such that the light beam approximately emerges in a forward direction when being emergent to the third surface 141 of the second optical film 140. Based on the above, the backlight module 100 in the embodiment is configured with the two optical films (the first optical film 130 and the second optical film 140), so that the emergent brightness at the forward viewing angle can be effectively improved. Therefore, the backlight module 100 in the embodiment can improve the brightness and contrast, and reduce the thickness.

Referring to FIG. 1, the backlight module 100 can further include a reflecting sheet 150. The reflecting sheet 150 is arranged on a side, opposite to the first optical film 130, of the light guide plate 120, to improve the light utilization ratio. In the embodiment, the material of the reflecting sheet 150 can include silver, which is not limited in the present invention.

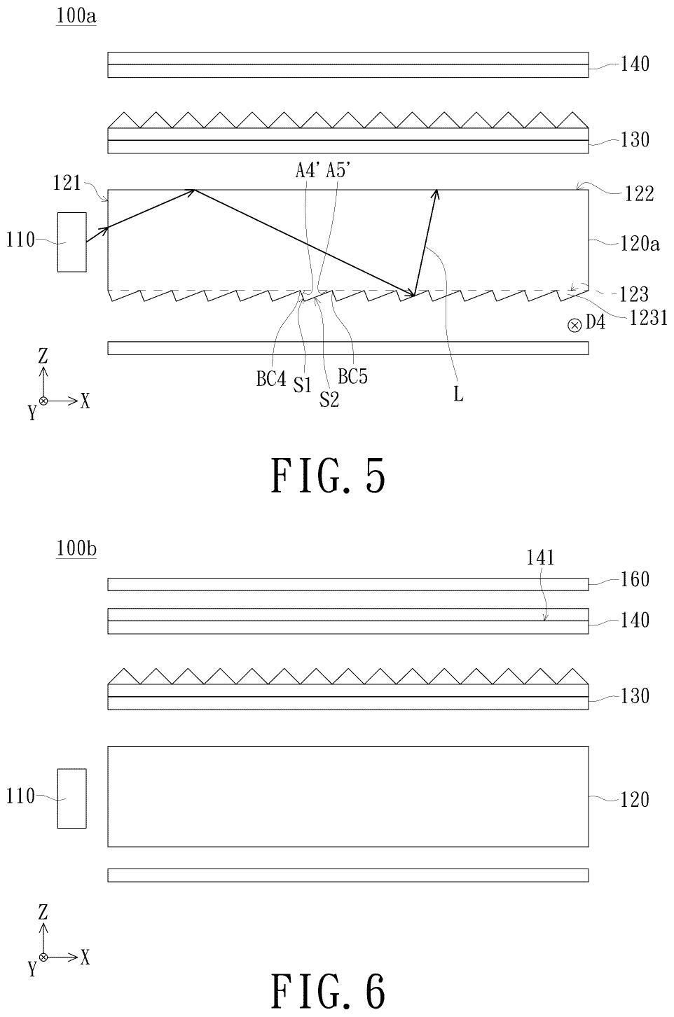

FIG. 5 is a schematic diagram of a backlight module in another embodiment of the present invention. The structure and advantages of the backlight module 100a in the embodiment are similar to those in the embodiment shown in FIG. 1, and only the differences will be described below. Referring to FIG. 5, the light guide plate 120a further has, for example, a fourth surface 123. The fourth surface 123 is opposite to the light-outlet surface 122 and has a plurality of triangular prism optical structures 1231. The fourth axial direction D4 of each of the triangular prism optical structures 1231 extends along the fourth surface 123 and the light-inlet surface 121. For example, the fourth axial direction D4 can extend in the direction Y, the fourth surface 123 can extend along the X-Y plane, and the light-inlet surface 121 can extend along the Y-Z plane. The triangular prism optical structure 1231 has a fourth base angle BC4 and a fifth base angle BC5. The fourth base angle BC4 and the fifth base angle BC5 are connected to the fourth surface 123, and the fourth base angle BC4 of each of the triangular prism optical structures 1231 is closer to the light-inlet surface 121, compared with the fifth base angle BC5. The angle A4′ of the fourth base angle BC4 can be larger than the angle A5′ of the fifth base angle BC5. Therefore, the triangular prism optical structure 1231 can reflect more light beams L to the light-outlet surface 122, and the light beams L reflected by the triangular prism optical structure 1231 can be incident to the light-outlet surface 122 at a smaller angle so that the light emergent brightness and contrast of the backlight module 100a are further improved.

In detail, the triangular prism optical structure 1231 further has, for example, a surface S1 and a surface S2. The surfaces S1 and S2 are connected to the fourth surface 123, where the connection between the surface S1 and the fourth surface 123 is the fourth base angle BC4, and the connection between the surface S2 and the fourth surface 123 is the fifth base angle BC5. Further, the light beams (for example, the light beam L) incident to the triangular column optical structure 1231 are mostly reflected to the light-outlet surface 122 by the surface S2, and a small part of the light beams will be reflected to the light-outlet surface 122 by the surface S1. Because the angle A4′ of the fourth base angle BC4 is larger than the angle A5′ of the fifth base angle BC5, the slope of the surface S2 relative to the fourth surface 123 is less than that of the surface S1 relative to the fourth surface 123, and the area of the surface S2 is larger than the area of the surface S1. Therefore, the amount of the light beams incident to the surface S2 is increased, and the light beam L reflected by the surface S2 can be emergent to the emergent surface 122 at a smaller angle so that the light emergent brightness and contrast of the backlight module 100a are further improved.

FIG. 6 is a schematic diagram of a backlight module in another embodiment of the present invention. The structure and advantages of the backlight module 100b in the embodiment are similar to those in the embodiment shown in FIG. 1, and only the differences will be described below. Referring to FIG. 6, the backlight module 100b further includes an optical film 160. The optical film 160 is arranged opposite the third surface 141, and the optical film 160 can include a light-diffusing sheet or a brightness-enhancing sheet. However, in an embodiment, the backlight module 100b can further be provided with optical films 160 of different types. It is to be understood that there can be one optical film 160. But in another embodiment, there can be a plurality of optical films 160.

In conclusion, the backlight module provided by the present invention uses the first optical film and the second optical film, where the first columnar optical structure can diffuse an incident light beam, such that the light beam can be more uniformly incident to the second columnar optical structure, and the second columnar optical structure can reduce an emergent opening angle of the light beam at a vertical viewing angle. On the other hand, the third columnar optical structure of the second optical film can reduce the emergent opening angle of the light beam at a horizontal viewing angle, such that the light beam approximately emerges in a forward direction when being emergent to the third surface of the second optical film. Based on the above, the backlight module provided by the present invention is configured with the two optical films (the first optical film and the second optical film), so that the emergent brightness at the forward viewing angle can be effectively improved. Therefore, the backlight module provided by the present invention can improve the brightness and contrast, and reduce the thickness.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A backlight module, comprising:
a light-emitting element;
a light guide plate, having a light-inlet surface and a light-outlet surface connected to each other, wherein the light-inlet surface is opposite to the light-emitting element;
a first optical film, having a first surface, a second surface, and a side surface, wherein the first surface is opposite to the second surface and faces the light-outlet surface, the side surface is located between the first surface and the second surface, the side surface and the light-inlet surface are located on a same side of the backlight module, the first surface has a plurality of first columnar optical structures, a first axial direction of each of the plurality of first columnar optical structures extends along the first surface, the second surface has a plurality of second columnar optical structures, a second axial direction of each of the plurality of second columnar optical structures extends along the second surface, wherein an included angle between each of the plurality of first axial directions and the side surface is A1, an included angle between each of the plurality of second axial directions and each of the plurality of first axial directions is A2, and A1≤90° and A2≤90°; and
a second optical film, arranged opposite to the first optical film and having a third surface opposite to the second surface, wherein the third surface has a plurality of third columnar optical structures, a third axial direction of each of the plurality of third columnar optical structures extends along the third surface, an included angle between each of the plurality of third axial directions and each of the plurality of first axial directions is A3, and A3≤45°.

2. The backlight module according to claim 1, wherein a shape of each of the first columnar optical structures comprises a triangular prism and has two first base angles connected to the first surface, and angles of the two first base angles of each of the plurality of first columnar optical structures are equal to each other and are between 1° and 60°, respectively.

3. The backlight module according to claim 1, wherein each of the plurality of first columnar optical structures has a first top opposite to the first surface, and a distance between the two first tops of the two adjacent first columnar optical structures in the first columnar optical structures is between 25 um and 50 um.

4. The backlight module according to claim 3, wherein a shape of each of the plurality of first columnar optical structures comprises a triangular prism, and each of the plurality of first tops comprises a vertex angle of each of the first columnar optical structures.

5. The backlight module according to claim 1, wherein a refractive index of each of the plurality of first columnar optical structures is greater than 1.5.

6. The backlight module according to claim 1, wherein a shape of each of the plurality of second columnar optical structures comprises a triangular prism and has two second base angles connected to the second surface, and angles of the two second base angles of each of the plurality of second columnar optical structures are equal to each other and are between 1° and 60°, respectively.

7. The backlight module according to claim 1, wherein each of the plurality of second columnar optical structures has a second top opposite to the second surface, and a distance between the two second tops of the two adjacent second columnar optical structures in the second columnar optical structures is between 25 um and 50 um.

8. The backlight module according to claim 7, wherein a shape of each of the plurality of second columnar optical structures comprises a triangular prism, and each of the plurality of second tops comprises a vertex angle of each of the second columnar optical structures.

9. The backlight module according to claim 1, wherein a refractive index of each of the plurality of second columnar optical structures is greater than 1.5.

10. The backlight module according to claim 1, wherein a shape of each of the plurality of third columnar optical structures comprises a triangular prism and has two third base angles connected to the third surface, and angles of the two third base angles of each of the third columnar optical structures are equal to each other and are between 1° and 60°, respectively.

11. The backlight module according to claim 1, wherein each of the plurality of third columnar optical structures has a third top opposite to the third surface, and a distance between the two third tops of the two adjacent third columnar optical structures in the third columnar optical structures is between 25 um and 50 um.

12. The backlight module according to claim 11, wherein a shape of each of the plurality of third columnar optical structures comprises a triangular prism, and each of the plurality of third tops comprises a vertex angle of each of the third columnar optical structures.

13. The backlight module according to claim 1, wherein a refractive index of each of the plurality of third columnar optical structures is greater than 1.5.

14. The backlight module according to claim 1, wherein the light guide plate further has a fourth surface, the fourth surface is opposite to the light-outlet surface and has a plurality of triangular prism optical structures, a fourth axial direction of each of the plurality of triangular prism optical structures extends along the fourth surface and the light-inlet surface, each of the plurality of triangular prism optical structures has a fourth base angle and a fifth base angle, the fourth base angles and the fifth base angles are connected to the fourth surface, the fourth base angles of each of the plurality of triangular prism optical structures are closer to the light-inlet surface compared with the fifth base angles, and angles of the fourth base angles are larger than angles of the fifth base angles.

15. The backlight module according to claim 1, further comprising an optical film, wherein the optical film is arranged opposite the third surface and comprises a light-diffusing sheet or a brightness-enhancing sheet.

16. The backlight module according to claim 1, further comprising a reflecting sheet, wherein the reflecting sheet is arranged on a side, opposite to the first optical film, of the light guide plate.
